(19) United States
(12) Patent Application Publication
(10) Pub. No.: US 2014/0310681 A1
(43) Pub. Date: Oct. 16, 2014

(54) ASSISTED CREATION OF CONTROL EVENT

(71) Applicant: MICROSOFT CORPORATION, Redmond, WA (US)

(72) Inventors: Suraj T. Poozhiyil, Redmond, WA (US); Vijay Mital, Kirkland, WA (US); Nizam Anuar, Snoqualmie, WA (US); Benjamin Hodes, Seattle, WA (US); Bao Quoc Nguyen, Redmond, WA (US)

(21) Appl. No.: 13/862,265

(22) Filed: Apr. 12, 2013

(51) Int. Cl. G06F 9/44

(52) U.S. Cl. CPC G06F 8/10
USPC 717/104

(57) ABSTRACT

The facilitated selection of an event that would trigger a control to perform a behavior. The control has multiple events that that may be used to trigger a behavior. It could perhaps be difficult for a user, especially a non-programmer, to select the appropriate event that triggers any given behavior. The system helps by automatically identifying a set of one or more events that are consistent with an intent for the control to perform a behavior of interest, in response to the user specifying the behavior. The automatically identified event might also depend on data of interest that the user identifies as to be operated upon by the control in performing the behavior. The system might propose one or more of the automatically identified events, and might even automatically configure the control to perform the behavior in response to a selected event.

### BACKGROUND

A “recalculation document” is an electronic document that shows various data sources and data sinks, and allows for a declarative transformation between a data source and a data sink. For any given set of transformations interconnecting various data sources and data sinks, the output of the data source may be consumed by the data sink, or the output of the data source may be subject to transformations prior to being consumed by the data sink. These various transformations are evaluated resulting in one or more outputs represented throughout the recalculation document.

The user can add and edit the declarative transformations without having in-depth knowledge of coding. Such editing automatically causes the transformations to be recalculated, causing a change in one of more outputs.

A specific example of a recalculation document is a spreadsheet document, which includes a grid of cells. Any given cell might include an expression that is evaluated to output a particular value that is displayed in the cell. The expression might refer to a data source, such as one or more other cells or values.

### BRIEF SUMMARY

At least some embodiments described herein relate to the facilitated selection of an event that would trigger a control to perform a behavior. The control has multiple events that that may be used to trigger a behavior. It could perhaps be difficult for a user, especially a non-programmer, to select the appropriate event that triggers any given behavior. The system helps by automatically identifying a set of one or more events that are consistent with an intent for the control to perform a behavior of interest, in response to the user specifying the behavior. The automatically identified event might also depend on data of interest that the user identifies as to be operated upon by the control in performing the behavior. The system might propose one or more of the automatically identified events, and might even automatically configure the control to perform the behavior in response to a selected event.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a control that is capable of performing multiple behaviors and which has available a number of events for use in triggering behaviors;

FIG. 3 illustrates a hierarchically-structured compound control;

FIG. 4 illustrates a flowchart of a method for configuring a control to perform a behavior;

FIG. 5 abstractly illustrates an example recalculation user interface, which illustrates several data sources and data sinks with intervening transforms;

FIG. 6 illustrates an example compilation environment that includes a compiler that accesses the transformation chain and produces compiled code as well as a dependency chain; and

FIG. 7 illustrates a flowchart of a method for compiling a transformation chain of a recalculation user interface;

FIG. 8 illustrates an environment in which the principles of the present invention may be employed including a data-driven composition framework that constructs a view composition that depends on input data;

FIG. 9 illustrates a pipeline environment that represents one example of the environment of FIG. 8;

FIG. 10 schematically illustrates an embodiment of the data portion of the pipeline of FIG. 9;

FIG. 11 schematically illustrates an embodiment of the analytics portion of the pipeline of FIG. 9; and

FIG. 12 schematically illustrates an embodiment of the view portion of the pipeline of FIG. 9.

### DETAILED DESCRIPTION

At least some embodiments described herein relate the facilitated selection of an event that would trigger a control to perform a behavior. The control has multiple events that that may be used to trigger a behavior. It could perhaps be difficult for a user, especially a non-programmer, to select the appropriate event that triggers any given behavior. The system helps by automatically identifying a set of one or more events that are consistent with an intent for the control to perform a behavior of interest, in response to the user specifying the behavior. The automatically identified event might also depend on data of interest that the user identifies as to be operated upon by the control in performing the behavior. The system might propose one or more of the automatically identified events, and might even automatically configure the control to perform the behavior in response to a selected event.

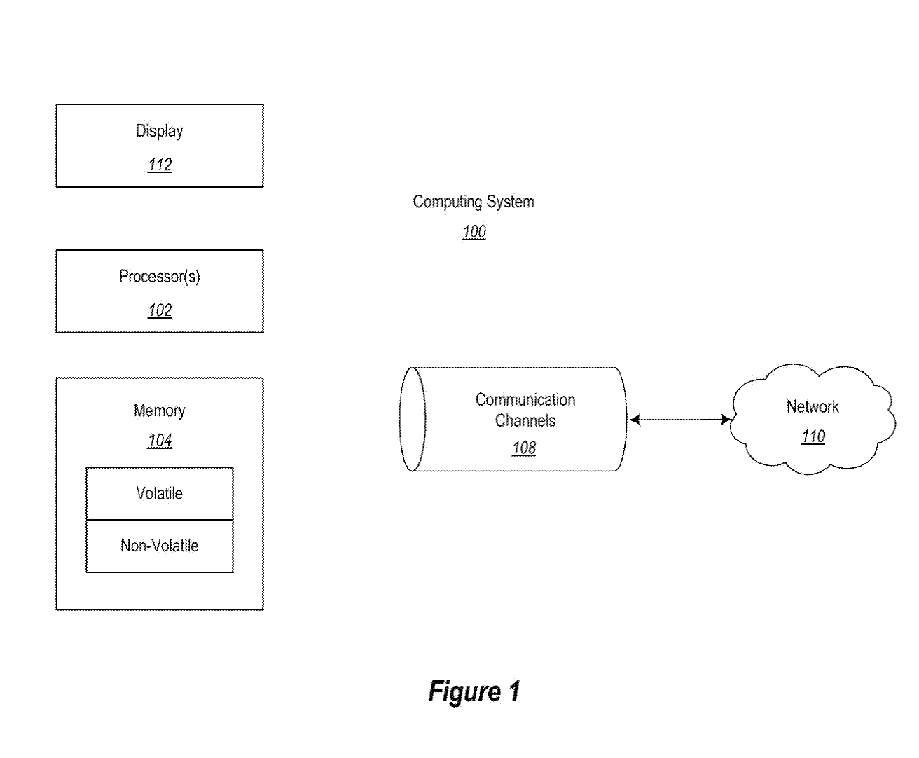

Some introductory discussion of a computing system will be described with respect to FIG. 1. Then, the process of facilitating the selection of an event that is used to trigger a control to perform a behavior will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also includes a display 112, which may be used to display visual representations to a user.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

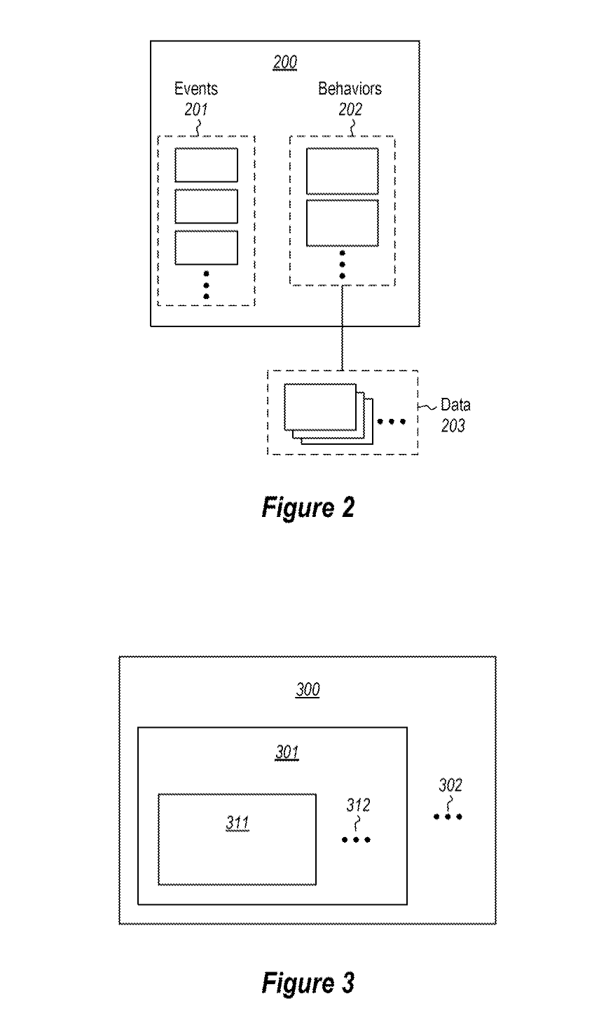

FIG. 2 illustrates a control 200 that is capable of performing multiple behaviors 202. The behaviors are general actions that may be performed by the control, and include a corresponding name that may be easily recognized by a user, even if the user is not a programmer. The behaviors 202 no not necessarily correspond to any identified code within the control 200, but are just general actions performed by the control 200.

Some of the behaviors 202 may perform the generate action on data. Accordingly, the control 200 is illustrated as having access to data 203. In one example, the data 203 represents properties of the control 200, although the data 203 may alternatively or in addition be data that is external to the control 200. The control 200 has a set of events 201 that may be associated with a behavior to trigger the performance of a behavior (e.g., one or more of behaviors 202) on perhaps an identified item data (e.g., one or more of data items 203).

The control 200 may be a component that is maintained on the computing system 100. For instance, the control 200 may be instantiated and/or operated in response to the one or more processors 102 executing computer-executable instructions that are embodied on a computer-readable media, such as a computer-readable storage media.

The control 200 may be a visualization control or a signal capture control. A visualization control is a control that displays in a certain manner depending on one or more of its parameters. On the other hand, a signal capture control is configured to capture an environment signal. Examples of environmental signals that may be captured by the signal capture control include images, video, audio, sound levels, orientation, location, biometrics, weather, acceleration, pressure, and so forth.

FIG. 3 illustrates a hierarchically-structured compound control 300. In this description or in the claims, a “compound control” is a control that includes constituent controls and/or has peer controls. For instance, the compound control 300 includes a child control 301 as well as potentially other child controls as represented by the ellipses 302. Similarly, the child control 301 is itself a compound control as it includes its own child control 311 and potentially other child controls as represented by the ellipses 312. The control 200 may be any of the controls 300, 301 and 311 as the control 200 may be itself a compound control and/or a member control of a compound control.

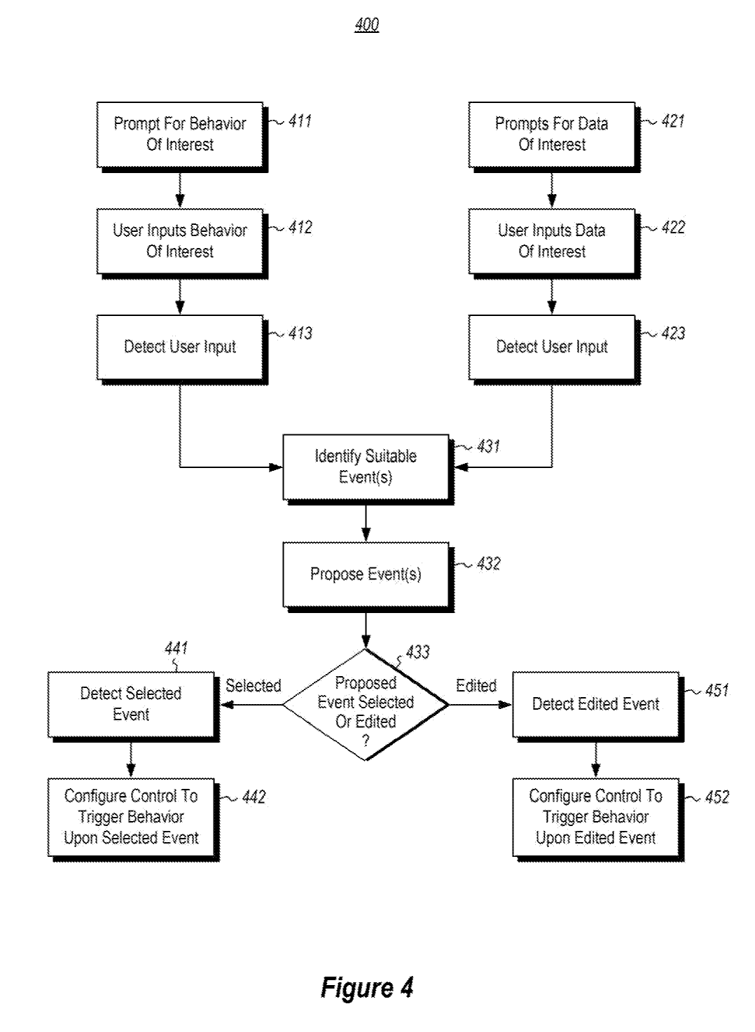

FIG. 4 illustrates a flowchart of a method 400 for configuring a control to perform a behavior. As the method 400 may be performed by the computing system 100 on the control 200, the method 400 will now be described with respect to FIGS. 1 and 2. As with any of the methods described herein, the method 400 may be performed by the computing system 100 in response to the one or more processors 102 executing computer-executable instructions embodied on a computer-readable media, such as a computer-readable storage media.

Optionally, the method 400 includes prompting the user for a statement of a behavior of interest (act 411). For instance, referring to FIGS. 1 and 2, the computing system 100 might use the display 112 to present the name (or another identifier) for each of the behaviors 202 of the control 200. In response, the user inputs a statement of the behavior of interest (act 412). For instance, the user might select one of the presented behaviors.

Alternatively, the user might just input in free-form (without prompting concerning selection options) the statement of the behavior of interest. For instance, the user might type in natural language a statement of the behavior of interest. The computing system might use that free-form statement to heuristically identify one of the behaviors 202 associated with the control 200. The method 400 then detects the user input representing the behaviors of interest to be performed by the control (act 413).

Optionally, the method 400 includes prompting the user for a statement of the data of interest (act 411) that the behavior is to operate upon. For instance, referring to FIGS. 1 and 2, the computing system 100 might use the display 112 to present the name (or another identifier) of each of the data items 203 of the control 200. In response, the user inputs a statement of the data of interest (act 422). For instance, the user might select one of the presented behaviors. The data item 203 may identify specific data, collections of data, or a category or categories of data.

Alternatively, the user might just input in free-form (without prompting concerning selection options) the statement of the data of interest. For instance, the user might type in natural language a statement of the data of interest. The computing system might use that free-form statement to heuristically identify one of the data items 203 that the identified behavior is to operate upon. The method 400 then detects the user input representing the data of interest (act 423). The acts 421 through 423 are optional, particular for behaviors that do not operate upon data.

The method 400 then automatically identifies a set of one or more events that are consistent with an intent to perform the identified behavior of interest (on the identified data of interest if acts 422 and 423 is performed) (act 431). The method 400 then involves proposing at least one of the set of one or more identified events to the user (act 432).

An authoring program that helps users author controls may be running on the computing system 100. One of the functions of the authoring program may be to help the user identify events of a control that would be suitable to trigger the control to perform a behavior. Such events may be identified in advance of shipping the authoring program by an experienced programmer. For instance, for each control type, the programmer might identify possible behaviors. For each possible behavior, the programmer might identify possible categories of data that may be operated upon. Thus, during authoring of a control of a particular control type, when a non-programmer identifies the behavior (and possible also the data to be operated upon), the computing system might identify the set of one or more events previously identified by the programmer. Alternatively, the computing system itself may apply some or all of the intelligence that the programmer applied in identifying suitable events given a control, given a behavior, and given certain data.

The user may select one of the proposed events (“Selected” in decision block 433). For instance, the selected event may be one or more events 210 of the control 200 of FIG. 2. The computing system then detects that the user has selected a proposed event (act 441). In response, the computing system automatically configures the control to perform the behavior when the selected event occurs (act 442). For instance, the programmer that authored the authoring program may also author imperative code that causes this configuration to occur. The imperative code may be executed upon detection of the selected event.

One the other hand, the user may edit one of the proposed events (“Edit” in decision block 433). The computing system then detects that the user has selected a proposed event (act 451). For instance, the event might be edited to narrow the scope of the event. As an example, an event associated with a slider control may be a movement of the slider control. However, the user might further edit the event such that the event triggers only if the slider control moves while above a half-way point of the slider range. In response to the editing, the computing system automatically configures the control to perform the behavior when the edited event occurs (act 452).

The principles described herein are particular helpful in the context of authoring a recalculation user interface, as a non-programmer may more easily and intuitively select events that trigger behaviors of controls, regardless of how complex the control is. For instance, the control 200 may be included within a recalculation user interface.

In this description and in the claims, a “recalculation user interface” is an interface with which a user may interact and which occurs in an environment in which there are one or more data sources and one or more data sinks. Furthermore, there is a set of transformations that may each be declaratively defined between one or more data sources and a data sink. For instance, the output of one data source is fed into the transformation, and the result from the transformation is then provided to the data sink, resulting in potentially some kind of change in visualization to the user.

The transformations are “declarative” in the sense that a user without specific coding knowledge can write the declarations that define the transformation. As the transformation is declaratively defined, a user may change the declarative transformation. In response, a recalculation is performed, resulting in perhaps different data being provided to the data sinks.

A classic example of a recalculation user interface is a spreadsheet document. A spreadsheet document includes a grid of cells. Initially, the cells are empty, and thus any cell of the spreadsheet program has the potential to be a data source or a data sink, depending on the meaning and context of declarative expressions inputted by a user. For instance, a user might select a given cell, and type an expression into that cell. The expression might be as simple as an expressed scalar value to be assigned to that cell. That cell may later be used as a data source. Alternatively, the expression for a given cell might be in the form of an equation in which input values are taken from one or more other cells. In that case, the given cell is a data sink that displays the result of the transformation. However, during continued authoring, that cell may be used as a data sink for yet other transformations declaratively made by the author.

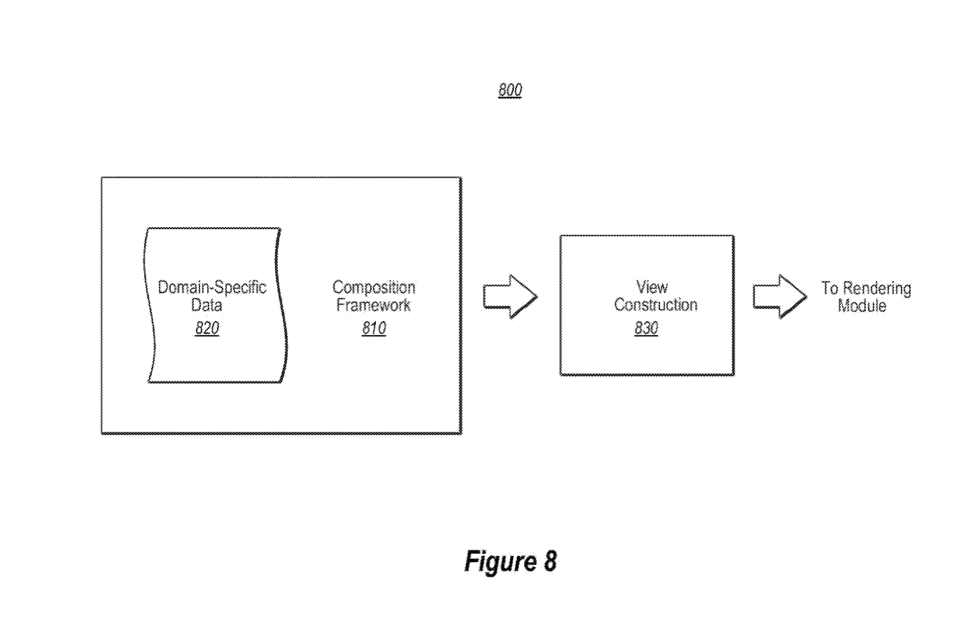

The author of a spreadsheet document need not be an expert on imperative code. The author is simply making declarations that define a transformation, and selecting corresponding data sinks and data sources. FIGS. 8 through 12 described hereinafter provide a more generalized declarative authoring environment in which a more generalized recalculation user interface is described. In that subsequently described environment, visualized controls may serve as both data sources and data sinks. Furthermore, the declarative transformations may be more intuitively authored by simple manipulations of those controls.

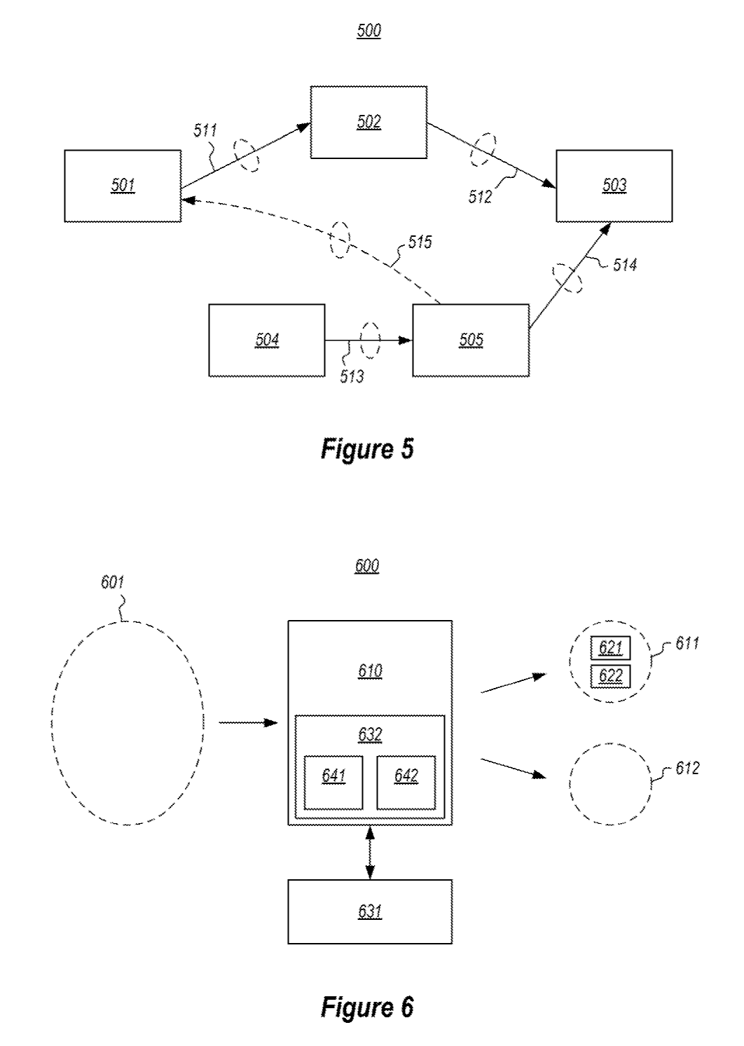

FIG. 5 abstractly illustrates an example recalculation user interface 500, which is a specific example provided to explain the broader principles described herein. The recalculation user interface 500 is just an example as the principles describe herein may be applied to any recalculation user interface to create a countless variety of recalculation user interfaces for a countless variety of applications.

The recalculation user interface 500 includes several declarative transformations 511 through 515. The dashed circle around each of the arrows representing the transformations 511 through 516 symbolizes that the transformation s are each in declarative form.

In this specific example of FIG. 5, the transform 511 includes respective data source 501 and data sink 502. Note that a data sink for one transform may also be a data source for another transform. For instance, data sink 502 for transform 511 also serves as a data source for the transform 512. Furthermore, a transform may have multiple data sources. Thus, the transform chain can be made hierarchical, and thus quite complex. For instance, the transform 512 includes data source 502 and data sink 503. The data sink 503 includes two data sources; namely data source 502 for transform 512, and data source 505 for transform 514. That said, perhaps a single transform leads the two data sources 502 and 505 into the data sink 503. The transform 513 includes a data source 504 and a data sink 505.

If the recalculation user interface were a spreadsheet document, for example, the various data sources/sinks 501 through 505 might be spreadsheet cells, in which case the transforms represent the expression that would be associated with each data sink. The output of each expression is displayed within the cell. Thus, in the case of a spreadsheet. The data sources/sinks might be complex visualized controls that have both include input parameters to and output parameters from the transformation chain. For instance, in FIG. 5, there is an additional declarative transformation 515 that leads from data source 505 into data sink 501. Thus, the data source/sink 501 might visualize information representing an output from transform 515, as well as provide further data to other data sinks.

Recalculation user interfaces do not need to have visualization controls. One example of this is a recalculation user interface meant to perform a transformation-based computation, consuming source data and updating sink data, with no information displayed to the user about the computation in the normal case. For instance, the recalculation user interface might support a background computation. A second example is a recalculation user interface that has output controls that operate external actuators, such as the valves in the process control example. Such controls are like display controls in that their states are controlled by results of the transformation computation and on signal inputs. However, here, the output is a control signal to a device rather than a visualization to a display. Consider, for example, a recalculation user interface for controlling a robot. This recalculation user interface might have rules for robot actions and behavior that depend on inputs robot sensors like servo positions and speeds, ultrasonic range-finding measurements, and so forth. Or consider a process control application based on a recalculation user interface that takes signals from equipment sensors like valve positions, fluid flow rates, and so forth.

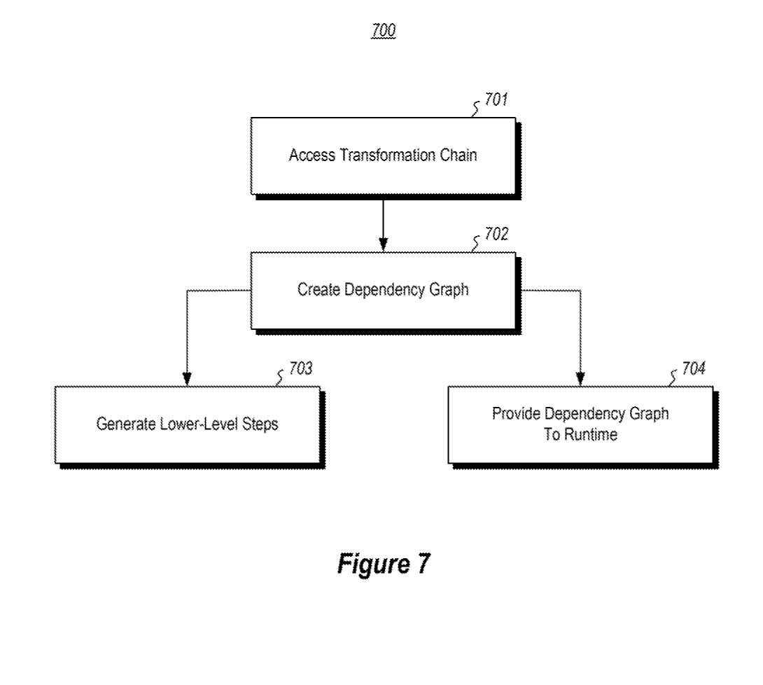

FIG. 6 illustrates an example compilation environment 600 that includes a compiler 610 that accesses the transformation chain 601. An example, of the transformation chain 601 is the transformation chain 500 of FIG. 5. FIG. 7 illustrates a flowchart of a method 700 for compiling a transformation chain of a recalculation user interface. The method 700 may be performed by the compiler 610 of FIG. 6. In one embodiment, the method 700 may be performed by the computing system 100 in response to the processor(s) 102 executing computer-executable instructions embodied on one or more computer-readable storage media.

The method 700 includes analyzing a transformation chain of the recalculation user interface for dependencies (act 701). For instance, referring to FIG. 5, the compiler 600 might analyze each of the transformations 511 through 515. The transformations are declarative and thus the dependencies can be extracted more easily than they could if the transformations were expressed using an imperative computer language.

Based on the analysis, a dependency graph is created (act 702) between entities referenced in the transformations. Essentially, the dependencies have a source entity that represents an event, and a target entity that represents that the evaluation of that target entity depends on the event. An example of the event might be a user event in which the user interacts in a certain way with the recalculation user interface. As another example, the event might be an inter-entity event in which if the source entity is evaluated, then the target entity of the dependency should also be evaluated.

The compiler then creates lower-level execution steps based on the dependency graph (act 703). The lower-level execution steps might be, for instance, imperative language code. Imperative language code is adapted to respond to detect events, reference an event chart to determine a function to execute, and execute that function. Accordingly, each of the dependencies in the dependency graph may be reduced to a function. The dependency graph itself may be provided to the runtime (act 704). The imperative language code may be, for example, a script language, such as JAVASCRIPT. However, the principles described herein are not limited to the imperative language code being of any particular language.

As an example, FIG. 6 illustrates that the compiler 610 generates lower-level code 611 as well. Such lower level code 611 includes a compilation of each of the transformations in the transformation chain. For instance, lower level code 611 is illustrated as including element 621 representing the compilation of each of the transformations in the transformation chain. In the context of FIG. 5, the element 621 would include a compilation of each of the transformations 511 through 515. The lower level code 611 also includes a variety of functions 622. A function is generated for each dependency in the dependency graph. The functions may be imperative language functions.

When the imperative language runtime detects an event that is listed in the dependency graph, the corresponding function within the compiled functions 622 is also executed. Accordingly, with all transformations being properly compiled, and with each of the dependencies on particular events being enforced by dedicated functions, the declarative recalculation user interface is properly represented as an imperative language code.

Accordingly, an effective mechanism has been described for compiling a declarative recalculation user interface. In addition, the runtime is provided with a dependency graph, rather than a more extensive interpreter.

A specific example of an authoring pipeline for allowing non-programmers to author programs having complex behaviors using a recalculation user interface will now be described with respect to FIGS. 8 through 12.

FIG. 8 illustrates a visual composition environment 800 that may be used to construct an interactive visual composition in the form of a recalculation user interface. The construction of the recalculation user interface is performed using data-driven analytics and visualization of the analytical results. The environment 800 includes a composition framework 810 that performs logic that is performed independent of the problem-domain of the view composition 830. For instance, the same composition framework 810 may be used to compose interactive view compositions for city plans, molecular models, grocery shelf layouts, machine performance or assembly analysis, or other domain-specific renderings.

The composition framework 810 uses domain-specific data 820, however, to construct the actual visual composition 830 that is specific to the domain. Accordingly, the same composition framework 810 may be used to construct recalculation user interfaces for any number of different domains by changing the domain-specific data 820, rather than having to recode the composition framework 810 itself. Thus, the composition framework 810 of the pipeline 800 may apply to a potentially unlimited number of problem domains, or at least to a wide variety of problem domains, by altering data, rather than recoding and recompiling. The view composition 830 may then be supplied as instructions to an appropriate 2-D or 3-D rendering module. The architecture described herein also allows for convenient incorporation of pre-existing view composition models as building blocks to new view composition models. In one embodiment, multiple view compositions may be included in an integrated view composition to allow for easy comparison between two possible solutions to a model.

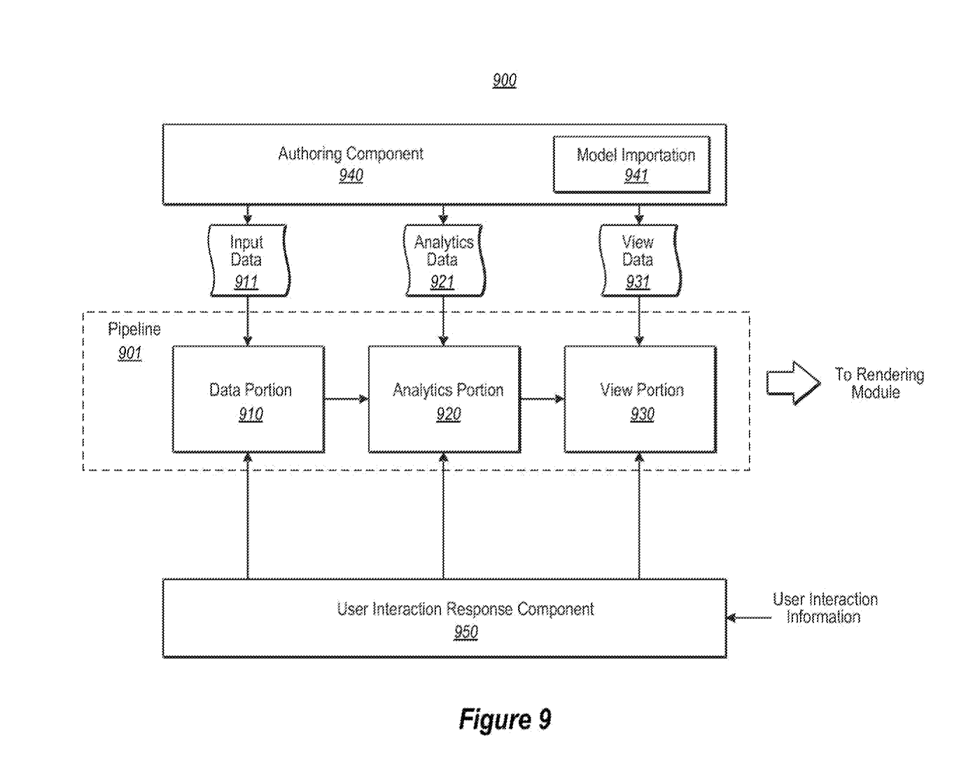

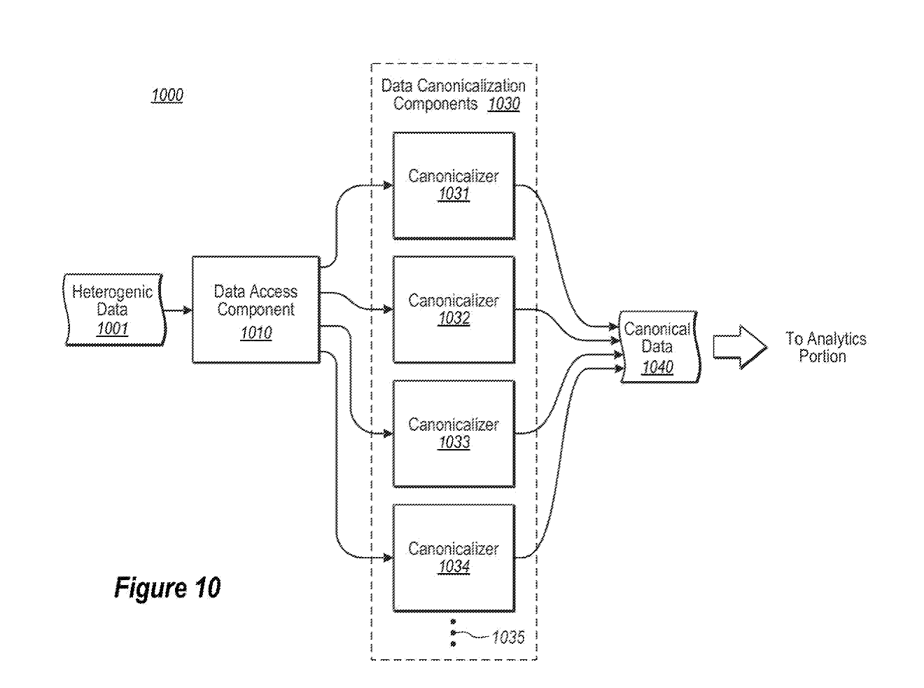

FIG. 9 illustrates an example architecture of the composition framework 510 in the form of a pipeline environment 900. The pipeline environment 900 includes, amongst other things, the pipeline 901 itself. The pipeline 901 includes a data portion 910, an analytics portion 920, and a view portion 1630, which will each be described in detail with respect to subsequent FIGS. 10 through 12, respectively, and the accompanying description. For now, at a general level, the data portion 910 of the pipeline 901 may accept a variety of different types of data and presents that data in a canonical form to the analytics portion 920 of the pipeline 901. The analytics portion 920 binds the data to various model parameters, and solves for the unknowns in the model parameters using model analytics. The various parameter values are then provided to the view portion 930, which constructs the composite view using those values if the model parameters. For instance, the data portion 610 may offer up data sources to the recalculation user interface.

The pipeline environment 900 also includes an authoring component 940 that allows an author or other user of the pipeline 901 to formulate and/or select data to provide to the pipeline 901. For instance, the authoring component 940 may be used to supply data to each of data portion 910 (represented by input data 911), analytics portion 920 (represented by analytics data 921), and view portion 930 (represented by view data 931). The various data 911, 921 and 931 represent an example of the domain-specific data 820 of FIG. 8, and will be described in much further detail hereinafter. The authoring component 940 supports the providing of a wide variety of data including for example, data schemas, actual data to be used by the model, the location or range of possible locations of data that is to be brought in from external sources, visual (graphical or animation) objects, user interface interactions that can be performed on a visual, modeling statements (e.g., views, equations, constraints), bindings, and so forth. In one embodiment, the authoring component is but one portion of the functionality provided by an overall manager component (not shown in FIG. 9, but represented by the composition framework 810 of FIG. 8). The manager is an overall director that controls and sequences the operation of all the other components (such as data connectors, solvers, viewers, and so forth) in response to events (such as user interaction events, external data events, and events from any of the other components such as the solvers, the operating system, and so forth).

In the pipeline environment 900 of FIG. 9, the authoring component 940 is used to provide data to an existing pipeline 901, where it is the data that drives the entire process from defining the input data, to defining the analytical model (referred to above as the “transformation chain”), to defining how the results of the transformation chain are visualized in the view composition. Accordingly, one need not perform any coding in order to adapt the pipeline 901 to any one of a wide variety of domains and problems. Only the data provided to the pipeline 901 is what is to change in order to apply the pipeline 901 to visualize a different view composition either from a different problem domain altogether, or to perhaps adjust the problem solving for an existing domain. Further, since the data can be changed at use time (i.e., run time), as well as at author time, the model can be modified and/or extended at runtime. Thus, there is less, if any, distinction between authoring a model and running the model. Because all authoring involves editing data items and because the software runs all of its behavior from data, every change to data immediately affects behavior without the need for recoding and recompilation.

The pipeline environment 900 also includes a user interaction response module 950 that detects when a user has interacted with the displayed view composition, and then determines what to do in response. For example, some types of interactions might require no change in the data provided to the pipeline 901 and thus require no change to the view composition. Other types of interactions may change one or more of the data 911, 921, or 931. In that case, this new or modified data may cause new input data to be provided to the data portion 910, might require a reanalysis of the input data by the analytics portion 920, and/or might require a re-visualization of the view composition by the view portion 930.

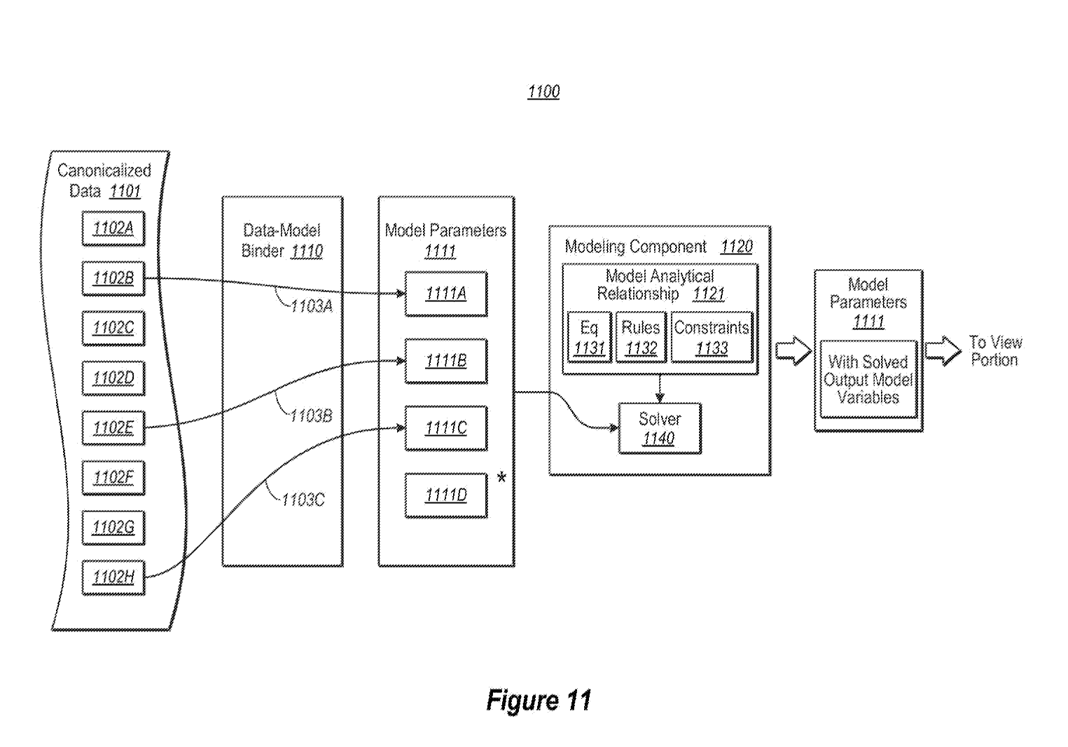

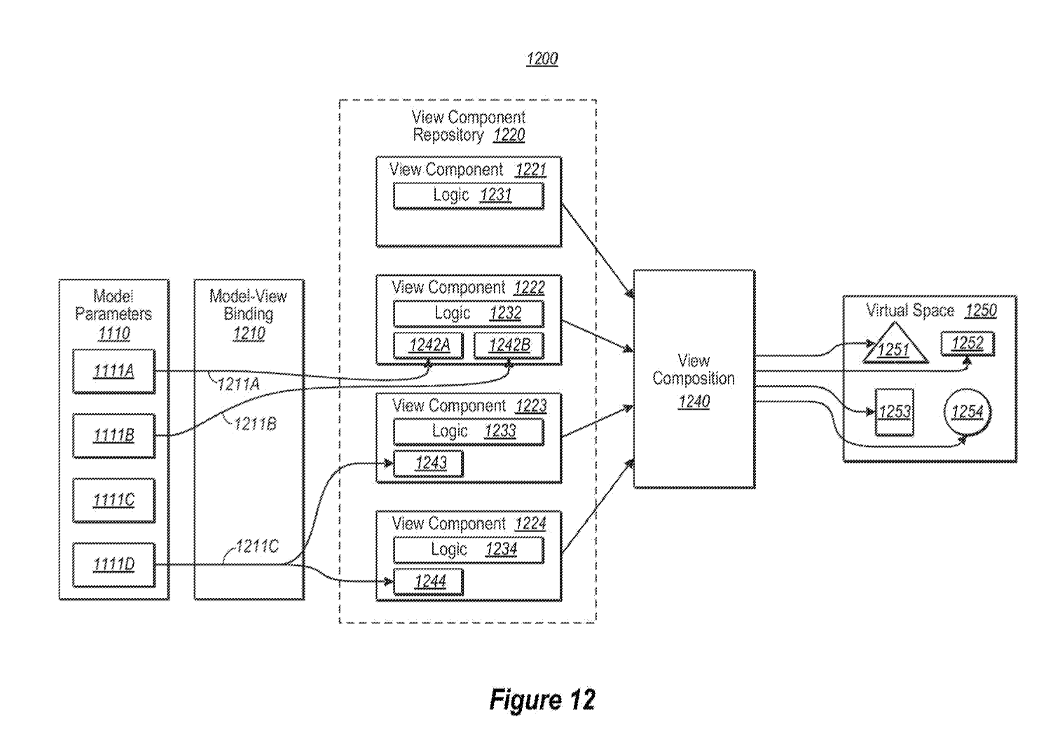

Accordingly, the pipeline 901 may be used to extend data-driven analytical visualizations to perhaps an unlimited number of problem domains, or at least to a wide variety of problem domains. Furthermore, one need not be a programmer to alter the view composition to address a wide variety of problems. Each of the data portion 910, the analytics portion 920 and the view portion 930 of the pipeline 901 will now be described with respect to respective data portion 1000 of FIG. 10, the analytics portion 1100 of FIG. 11, and the view portion 1200 of FIG. 12, in that order. As will be apparent from FIGS. 10 through 12, the pipeline 901 may be constructed as a series of transformation component where they each 1) receive some appropriate input data, 2) perform some action in response to that input data (such as performing a transformation on the input data), and 3) output data which then serves as input data to the next transformation component.

FIG. 10 illustrates just one of many possible embodiments of a data portion 1000 of the pipeline 901 of FIG. 9. One of the functions of the data portion 1000 is to provide data in a canonical format that is consistent with schemas understood by the analytics portion 1100 of the pipeline discussed with respect to FIG. 11. The data portion includes a data access component 1010 that accesses the heterogenic data 1001. The input data 1001 may be “heterogenic” in the sense that the data may (but need not) be presented to the data access component 1010 in a canonical form. In fact, the data portion 1000 is structured such that the heterogenic data could be of a wide variety of formats. Examples of different kinds of domain data that can be accessed and operated on by models include text and XML documents, tables, lists, hierarchies (trees), SQL database query results, BI (business intelligence) cube query results, graphical information such as 2D drawings and 3D visual models in various formats, and combinations thereof (i.e., a composite). Further, the kind of data that can be accessed can be extended declaratively, by providing a definition (e.g., a schema) for the data to be accessed. Accordingly, the data portion 1000 permits a wide variety of heterogenic input into the model, and also supports runtime, declarative extension of accessible data types.

In one embodiment, the data access portion 1000 includes a number of connectors for obtaining data from a number of different data sources. Since one of the primary functions of the connector is to place corresponding data into canonical form, such connectors will often be referred to hereinafter and in the drawings as “canonicalizers”. Each canonicalizer might have an understanding of the specific Application Program Interfaces (API's) of its corresponding data source. The canonicalizer might also include the corresponding logic for interfacing with that corresponding API to read and/or write data from and to the data source. Thus, canonicalizers bridge between external data sources and the memory image of the data.

The data access component 1010 evaluates the input data 1001. If the input data is already canonical and thus processable by the analytics portion 1100, then the input data may be directly provided as canonical data 1040 to be input to the analytics portion 1100.

However, if the input data 1001 is not canonical, then the appropriate data canonicalization component 1030 is able to convert the input data 1001 into the canonical format. The data canonicalization components 1030 are actually a collection of data canonicalization components 1030, each capable of converting input data having particular characteristics into canonical form. The collection of canonicalization components 1030 is illustrated as including four canonicalization components 1031, 1032, 1033 and 1034. However, the ellipses 1035 represents that there may be other numbers of canonicalization components as well, perhaps even fewer that the four illustrated.

The input data 1001 may even include a canonicalizer itself as well as an identification of correlated data characteristic(s). The data portion 1000 may then register the correlated data characteristics, and provide the canonicalization component to the data canonicalization component collection 1030, where it may be added to the available canonicalization components. If input data is later received that has those correlated characteristics, the data portion 1010 may then assign the input data to the correlated canonicalization component. Canonicalization components can also be found dynamically from external sources, such as from defined component libraries on the web. For example, if the schema for a given data source is known but the needed canonicalizer is not present, the canonicalizer can be located from an external component library, provided such a library can be found and contains the needed components. The pipeline might also parse data for which no schema is yet known and compare parse results versus schema information in known component libraries to attempt a dynamic determination of the type of the data, and thus to locate the needed canonicalizer components.

Alternatively, instead of the input data including all of the canonicalization component, the input data may instead provide a transformation definition defining canonicalization transformations. The collection 1030 may then be configured to convert that transformations definition into a corresponding canonicalization component that enforces the transformations along with zero or more standard default canonicalization transformation. This represents an example of a case in which the data portion 1000 consumes the input data and does not provide corresponding canonicalized data further down the pipeline. In perhaps most cases, however, the input data 1001 results in corresponding canonicalized data 1040 being generated.

In one embodiment, the data portion 1010 may be configured to assign input data to the data canonicalization component on the basis of a file type and/or format type of the input data. Other characteristics might include, for example, a source of the input data. A default canonicalization component may be assigned to input data that does not have a designated corresponding canonicalization component. The default canonicalization component may apply a set of rules to attempt to canonicalize the input data. If the default canonicalization component is not able to canonicalize the data, the default canonicalization component might trigger the authoring component 840 of FIG. 8 to prompt the user to provide a schema definition for the input data. If a schema definition does not already exist, the authoring component 840 might present a schema definition assistant to help the author generate a corresponding schema definition that may be used to transform the input data into canonical form. Once the data is in canonical form, the schema that accompanies the data provides sufficient description of the data that the rest of the pipeline 901 does not need new code to interpret the data. Instead, the pipeline 901 includes code that is able to interpret data in light of any schema that is expressible an accessible schema declaration language.

Regardless, canonical data 1040 is provided as output data from the data portion 1000 and as input data to the analytics portion 1100. The canonical data might include fields that include a variety of data types. For instance, the fields might include simple data types such as integers, floating point numbers, strings, vectors, arrays, collections, hierarchical structures, text, XML documents, tables, lists, SQL database query results, BI (business intelligence) cube query results, graphical information such as 2D drawings and 3D visual models in various formats, or even complex combinations of these various data types. As another advantage, the canonicalization process is able to canonicalize a wide variety of input data. Furthermore, the variety of input data that the data portion 1000 is able to accept is expandable. This is helpful in the case where multiple models are combined as will be discussed later in this description.

FIG. 11 illustrates analytics portion 1100 which represents an example of the analytics portion 920 of the pipeline 901 of FIG. 9. The data portion 1000 provided the canonicalized data 1101 to the data-model binding component 1110. While the canonicalized data 1101 might have any canonicalized form, and any number of parameters, where the form and number of parameters might even differ from one piece of input data to another. For purposes of discussion, however, the canonical data 1101 has fields 1102A through 1102H, which may collectively be referred to herein as “fields 1102”.

On the other hand, the analytics portion 1100 includes a number of model parameters 1111. The type and number of model parameters may differ according to the model. However, for purposes of discussion of a particular example, the model parameters 811 will be discussed as including model parameters 1111A, 1111B, 1111C and 1111D. In one embodiment, the identity of the model parameters, and the analytical relationships between the model parameters may be declaratively defined without using imperative coding.

A data-model binding component 1110 intercedes between the canonicalized data fields 1102 and the model parameters 1111 to thereby provide bindings between the fields. In this case, the data field 1102B is bound to model parameter 1111A as represented by arrow 1103A. In other words, the value from data field 1102B is used to populate the model parameter 1111A. Also, in this example, the data field 1102E is bound to model parameter 1111B (as represented by arrow 1103B), and data field 1102H is bound to model parameter 1111C (as represented by arrow 803C).

The data fields 1102A, 1102C, 1102D, 1102F and 1102G are not shown bound to any of the model parameters. This is to emphasize that not all of the data fields from input data are always required to be used as model parameters. In one embodiment, one or more of these data fields may be used to provide instructions to the data-model binding component 810 on which fields from the canonicalized data (for this canonicalized data or perhaps any future similar canonicalized data) are to be bound to which model parameter. This represents an example of the kind of analytics data 921 that may be provided to the analytics portion 920 of FIG. 9. The definition of which data fields from the canonicalized data are bound to which model parameters may be formulated in a number of ways. For instance, the bindings may be 1) explicitly set by the author at authoring time, 2) explicit set by the user at use time (subject to any restrictions imposed by the author), 3) automatic binding by the authoring component 940 based on algorithmic heuristics, and/or 4) prompting by the authoring component of the author and/or user to specify a binding when it is determined that a binding cannot be made algorithmically. Thus bindings may also be resolved as part of the model logic itself.

The ability of an author to define which data fields are mapped to which model parameters gives the author great flexibility in being able to use symbols that the author is comfortable with to define model parameters. For instance, if one of the model parameters represents pressure, the author can name that model parameter “Pressure” or “P” or any other symbol that makes sense to the author. The author can even rename the model parameter which, in one embodiment, might cause the data model binding component 1110 to automatically update to allow bindings that were previously to the model parameter of the old name to instead be bound to the model parameter of the new name, thereby preserving the desired bindings. This mechanism for binding also allows binding to be changed declaratively at runtime.

The model parameter 1111D is illustrated with an asterisk to emphasize that in this example, the model parameter 1111D was not assigned a value by the data-model binding component 1110. Accordingly, the model parameter 1111D remains an unknown. In other words, the model parameter 1111D is not assigned a value.

The modeling component 1120 performs a number of functions. First, the modeling component 1120 defines analytical relationships 1121 between the model parameters 1111. The analytical relationships 1121 are categorized into three general categories including equations 1131, rules 1132 and constraints 1133. However, the list of solvers is extensible. In one embodiment, for example, one or more simulations may be incorporated as part of the analytical relationships provided a corresponding simulation engine is provided and registered as a solver.

The term “equation” as used herein aligns with the term as it is used in the field of mathematics.

The term “rules” as used herein means a conditional statement where if one or more conditions are satisfied (the conditional or “if” portion of the conditional statement), then one or more actions are to be taken (the consequence or “then” portion of the conditional statement). A rule is applied to the model parameters if one or more model parameters are expressed in the conditional statement, or one or more model parameters are expressed in the consequence statement.

The term “constraint” as used herein means that a restriction is applied to one or more model parameters. For instance, in a city planning model, a particular house element may be restricted to placement on a map location that has a subset of the total possible zoning designations. A bridge element may be restricted to below a certain maximum length, or a certain number of lanes.

An author that is familiar with the model may provide expressions of these equations, rules and constraint that apply to that model. In the case of simulations, the author might provide an appropriate simulation engine that provides the appropriate simulation relationships between model parameters. The modeling component 1120 may provide a mechanism for the author to provide a natural symbolic expression for equations, rules and constraints. For example, an author of a thermodynamics related model may simply copy and paste equations from a thermodynamics textbook. The ability to bind model parameters to data fields allows the author to use whatever symbols the author is familiar with (such as the exact symbols used in the author's relied-upon textbooks) or the exact symbols that the author would like to use.

Prior to solving, the modeling component 1120 also identifies which of the model parameters are to be solved for (i.e., hereinafter, the “output model variable” if singular, or “output model variables” if plural, or “output model variable(s)” if there could be a single or plural output model variables). The output model variables may be unknown parameters, or they might be known model parameters, where the value of the known model parameter is subject to change in the solve operation. In the example of FIG. 11, after the data-model binding operation, model parameters 1111A, 1111B and 1111C are known, and model parameter 1111D is unknown. Accordingly, unknown model parameter 1111D might be one of the output model variables. Alternatively or in addition, one or more of the known model parameters 1111A, 1111B and 1111C might also be output model variables. The solver 840 then solves for the output model variable(s), if possible. In one embodiment described hereinafter, the solver 1140 is able to solve for a variety of output model variables, even within a single model so long as sufficient input model variables are provided to allow the solve operation to be performed. Input model variables might be, for example, known model parameters whose values are not subject to change during the solve operation. For instance, in FIG. 11, if the model parameters 1111A and 1111D were input model variables, the solver might instead solve for output model variables 1111B and 1111C instead. In one embodiment, the solver might output any one of a number of different data types for a single model parameter. For instance, some equation operations (such as addition, subtraction, and the like) apply regardless of the whether the operands are integers, floating point, vectors of the same, or matrices of the same.

In one embodiment, even when the solver 1140 cannot solve for a particular output model variables, the solver 1100 might still present a partial solution for that output model variable, even if a full solve to the actual numerical result (or whatever the solved-for data type) is not possible. This allows the pipeline to facilitate incremental development by prompting the author as to what information is needed to arrive at a full solve. This also helps to eliminate the distinction between author time and use time, since at least a partial solve is available throughout the various authoring stages. For an abstract example, suppose that the analytics model includes an equation a=b+c+d. Now suppose that a, c and d are output model variables, and b is an input model variable having a known value of 5 (an integer in this case). In the solving process, the solver 1140 is only able to solve for one of the output model variables “d”, and assign a value of 6 (an integer) to the model parameter called “d”, but the solver 840 is not able to solve for “c”. Since “a” depends from “c”, the model parameter called “a” also remains an unknown and unsolved for. In this case, instead of assigning an integer value to “a”, the solver might do a partial solve and output the string value of “c+11” to the model parameter “a”. As previously mentioned, this might be especially helpful when a domain expert is authoring an analytics model, and will essential serve to provide partial information regarding the content of model parameter “a” and will also serve to cue the author that some further model analytics needs to be provided that allow for the “c” model parameter to be solved for. This partial solve result may be perhaps output in some fashion in the view composition to allow the domain expert to see the partial result.

The solver 1140 is shown in simplified form in FIG. 11. However, the solver 1140 may direct the operation of multiple constituent solvers as will be described with respect to FIG. 12. In FIG. 11, the modeling component 1120 then makes the model parameters (including the now known and solved-for output model variables) available as output to be provided to the view portion 1200 of FIG. 12.

FIG. 12 illustrates a view portion 1200 which represents an example of the view portion 930 of FIG. 9, and represents example of visualized controls in the recalculation user interface 500. The view portion 1200 receives the model parameters 1111 from the analytics portion 1100 of FIG. 11. The view portion also includes a view components repository 1220 that contains a collection of view components. For example, the view components repository 1220 in this example is illustrated as including view components 1221 through 1224, although the view components repository 1220 may contain any number of view components. The view components each may include zero or more input parameters. For example, view component 1221 does not include any input parameters. However, view component 1222 includes two input parameters 1242A and 1242B. View component 1223 includes one input parameter 1243, and view component 1224 includes one input parameter 1244. That said, this is just an example. The input parameters may, but need not necessary, affect how the visual item is rendered. The fact that the view component 1221 does not include any input parameters emphasizes that there can be views that are generated without reference to any model parameters. Consider a view that comprises just fixed (built-in) data that does not change. Such a view might for example constitute reference information for the user. Alternatively, consider a view that just provides a way to browse a catalog, so that items can be selected from it for import into a model.

Each view component 1221 through 1224 includes or is associated with corresponding logic that, when executed by the view composition component 1240 using the corresponding view component input parameter(s), if any, causes a corresponding view item to be placed in virtual space 1250. That virtual item may be a static image or object, or may be a dynamic animated virtual item or object For instance, each of view components 1221 through 1224 are associated with corresponding logic 1231 through 1234 that, when executed causes the corresponding virtual item 1251 through 1254, respectively, to be rendered in virtual space 1250. The virtual items are illustrated as simple shapes. However, the virtual items may be quite complex in form perhaps even including animation. In this description, when a view item is rendered in virtual space, that means that the view composition component has authored sufficient instructions that, when provided to the rendering engine, the rendering engine is capable if displaying the view item on the display in the designated location and in the designated manner.

The view components 1221 through 1224 may be provided perhaps even as view data to the view portion 1200 using, for example, the authoring component 940 of FIG. 9. For instance, the authoring component 940 might provide a selector that enables the author to select from several geometric forms, or perhaps to compose other geometric forms. The author might also specify the types of input parameters for each view component, whereas some of the input parameters may be default input parameters imposed by the view portion 1200. The logic that is associated with each view component 1221 through 1224 may be provided also a view data, and/or may also include some default functionality provided by the view portion 1200 itself.

The view portion 1200 includes a model-view binding component 1210 that is configured to bind at least some of the model parameters to corresponding input parameters of the view components 1221 through 1224. For instance, model parameter 1111A is bound to the input parameter 1242A of view component 1222 as represented by arrow 1211A. Model parameter 1111B is bound to the input parameter 1242B of view component 1222 as represented by arrow 1211B. Also, model parameter 1111D is bound to the input parameters 1243 and 1244 of view components 1223 and 1224, respectively, as represented by arrow 1211C. The model parameter 1111C is not shown bound to any corresponding view component parameter, emphasizing that not all model parameters need be used by the view portion of the pipeline, even if those model parameters were essential in the analytics portion. Also, the model parameter 1111D is shown bound to two different input parameters of view components representing that the model parameters may be bound to multiple view component parameters. In one embodiment, The definition of the bindings between the model parameters and the view component parameters may be formulated by 1) being explicitly set by the author at authoring time, 2) explicit set by the user at use time (subject to any restrictions imposed by the author), 3) automatic binding by the authoring component 940 based on algorithmic heuristics, and/or 4) prompting by the authoring component of the author and/or user to specify a binding when it is determined that a binding cannot be made algorithmically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to perform a method for configuring a control in response to detecting user input representing a statement of a behavior of interest to be performed by the control, wherein the control has a plurality of events that may be used to trigger behaviors, the method comprising:
an act of automatically identifying a set of one or more events that are consistent with an intent to perform the behavior of interest.

2. The computer program product in accordance with claim 1, the method further comprising: an act of prompting the user for a statement of behavior of interest, wherein the act of prompting causes the user to input the statement of the behavior of interest.

3. The computer program product in accordance with claim 1, wherein the user input regarding a statement of a behavior of interest is free-form user input.

4. The computer program product in accordance with claim 1, wherein the method is further performed in response to detecting user input regarding data of interest that the behavior would operate upon.

5. The computer program product in accordance with claim 4, the method further comprising: an act of prompting the user for a statement of data of interest, which prompting causes the user to input the statement of the data of interest.

6. The computer program product in accordance with claim 4, wherein the act of automatically identifying comprises:
an act of automatically identifying a set of one or more events that are consistent with an intent to perform the behavior of interest on the data of interest.

7. The computer program product in accordance with claim 6, wherein the method further comprises:
an act of proposing at least one event of the set of one or more events to the user.

8. The computer program product in accordance with claim 7, the method further comprising the following in response to detecting that a user has edited a proposed event to be narrower than originally posed:
an act of automatically configuring the control to perform the behavior when the narrowed event occurs.

9. The computer program product in accordance with claim 6, the method further comprising the following in response to detecting a user selection of a proposed event:
an act of automatically configuring the control to perform the behavior when the selected event occurs.

10. The computer program product in accordance with claim 1, wherein the control is a signal capture control.

11. A method for configuring a control to perform a behavior, the method comprising:
an act of maintaining a control having a plurality of events that may be used to trigger a behavior;
an act of detecting user input representing a statement of a behavior of interest to be performed by the control; and
an act of automatically identifying a set of one or more events that are consistent with an intent to perform the behavior of interest.

12. The method in accordance with claim 11, wherein the control is a visualization control.

13. The method in accordance with claim 11, wherein the control is a compound control.

14. The method in accordance with claim 11, wherein the control is within a compound control.

15. The method in accordance with claim 11, wherein the control is included within a recalculation user interface.

16. The method in accordance with claim 15, wherein the recalculation user interface is a spreadsheet document.

17. The method in accordance with claim 11, further comprising:
an act of prompting the user for a statement of behavior of interest, wherein the act of prompting causes the user to input the statement of the behavior of interest.

18. The method in accordance with claim 11, further comprising:
an act of proposing at least one event of the set of one or more events to the user.

19. The method in accordance with claim 11, further comprising:
an act of detecting that the user has selected a proposed event; and
an act of automatically configuring the control to perform the behavior when the narrowed event occurs.

20. A method for configuring a control to perform a behavior, the control having a plurality of events that may be used to trigger a behavior, the method comprising:
an act of detecting user input representing a statement of a behavior of interest to be performed by the control; and
an act of automatically identifying a set of one or more events that are consistent with an intent to perform the behavior of interest;
an act of proposing at least one event of the set of one or more events to the user;
an act of detecting that the user has selected a proposed event; and
an act of automatically configuring the control to perform the behavior when the selected event occurs.
